(19) United States
(12) Patent Application Publication
(10) Pub. No.: US 2021/0150601 A1
(43) Pub. Date: May 20, 2021

(54) METHOD OF SELLING ADJUSTABLE GARMENT

(71) Applicant: EDITION WORLD WIDE CO., LTD., Seoul (KR)

(72) Inventors: Hyo Jeong KIM, Seoul (KR); Jinkyung LEE, Seoul (KR); Dongjun LEE, Seoul (KR); Ga Eun Sung, Seoul (KR)

(73) Assignee: EDITION WORLD WIDE CO., LTD., Seoul (KR)

(21) Appl. No.: 16/792,307

(22) Filed: Feb. 17, 2020

(30) Foreign Application Priority Data
Nov. 20, 2019 (KR) 10-2019-0149500

(51) Int. Cl. G06Q 30/06

(52) U.S. Cl. CPC G06Q 30/0621; G06Q 30/0643

(57) ABSTRACT

A method of selling an adjustable garment includes accessing a detachable garment site capable of selling detachable garments, selecting one of a plurality of vest parts in the accessed detachable garment site, displaying the selected vest part and selecting a first part to be attached to the vest part, displaying a first garment part, in which the selected first part is attached to the vest part, and selecting a second part to be attached to the first garment part, and displaying a second garment part, in which the selected second part is attached to the first garment part, and purchasing or cancelling the second garment part.

This application claims the priority benefit of Korean Patent Application No. 10-2019-0149500 filed on Nov. 20, 2019, which is incorporated herein by reference for all purposes as if fully set forth herein.

### BACKGROUND OF THE INVENTION

### Field of the Invention

The present disclosure relates to a method of selling an adjustable garment, and more particularly to a method of selling an adjustable garment in which a customer directly chooses desired material, color, and design of each part of a clothing product to make a single product and checks in advance and purchases combinations of desired parts of the clothing product online.

### Discussion of the Related Art

It is recognized that clothing can have a variety of variations due to its flexibility, but new clothing should be actually purchased according to the season, human body shape, or weight changes, etc. Further, the reality is that it is difficult to properly respond to various requests of people who feel cold or heat due to a difference in a temperature between day and night during one day.

Due to such problems, there is a need for a garment that is not fixed in one shape or one size and can be variously modified. Recently, various types of adjustable garments have been developed.

As a representative adjustable garment, there are known so-called a reversible garment that can be worn in two different colors and textures when turned inside out to create a variety of fashions, a detachable garment of which a specific part is detachable, and a garment of which a length or a width of a specific part can extend or shorten.

In case of the detachable garment, for example, Korean Patent No. 10-1656728 discloses a multi-variation garment that has an advantage of being able to create a garment with various feelings by means of a single garment because parts of the garment, such as a sleeve, a collar, a waist lower part, and a bottom garment, are detachable and a sleeve length, a shape of neckline, a length of the garment, etc. can be variously modified.

In addition, Korean Utility Model No. 455496 discloses a functional sports garment of which sleeve or part of the sleeve, a hat, etc. can be detach or deployed.

However, because most of the related art adjustable garments have variations using a method of detaching or reattaching an attached part such as sleeve, collar, and hat attached to the torso using a connection means such as a zipper, there is a problem that it is cumbersome to detach or reattach the part consisting of several pieces.

It is cumbersome to separately store the detached part after the detaching. In this case, the smaller the size and the more pieces are. Hence, there was a high risk of losing some pieces of the detached part.

### SUMMARY OF THE INVENTION

An object of the present disclosure is to address the above-described and other needs and/or problems.

Another object of the present disclosure is to provide a method of selling an adjustable garment in which a customer directly chooses desired material, color, and design of each part of a clothing product to make a single product and checks in advance and purchases a combination of desired parts of the clothing product online.

In one aspect, there is provided a method of selling an adjustable garment comprising accessing a detachable garment site capable of selling detachable garments; selecting one of a plurality of vest parts in the accessed detachable garment site; displaying the selected vest part and selecting a first part to be attached to the vest part; displaying a first garment part, in which the selected first part is attached to the vest part, and selecting a second part to be attached to the first garment part; and displaying a second garment part, in which the selected second part is attached to the first garment part, and purchasing or cancelling the second garment part.

The method may further comprise displaying the second garment part and selecting a third part to be attached to the second garment part; and displaying a third garment part, in which the selected third part is attached to the second garment part, and purchasing or cancelling the third garment part.

The first part or the second part may be attached to the vest part using one of a zipper, an open concealed zipper, a nylon zipper, a Vislon zipper, a snap, a magnet, a Velcro, a string, and a button. The third part may be attached to the second garment part using one of a zipper, an open concealed zipper, a nylon zipper, a Vislon zipper, a snap, a magnet, a Velcro, a string, and a button.

The method may further comprise displaying the third garment part and selecting a fourth part to be attached to the third garment part; and displaying a fourth garment part, in which the selected fourth part is attached to the third garment part, and purchasing or cancelling the fourth garment part.

The fourth part may be attached to the third garment part using one of a zipper, an open concealed zipper, a nylon zipper, a Vislon zipper, a snap, a magnet, a Velcro, a string, and a button.

The method may further comprise displaying the second garment part and selecting a fourth part to be attached to the second garment part; and displaying a fifth garment part, in which the selected fourth part is attached to the second garment part, and purchasing or cancelling the fifth garment part.

The fourth part may be attached to the second garment part using one of a zipper, an open concealed zipper, a nylon zipper, a Vislon zipper, a snap, a magnet, a Velcro, a string, and a button.

The second garment part or the third garment part may include a Triclimate garment or a reversible garment.

In another aspect, there is provided a method of selling an adjustable garment comprising accessing a detachable garment site capable of selling detachable garments; selecting one of a plurality of vest parts in the accessed detachable garment site; displaying the selected vest part and selecting a third part to be attached to the vest part; and displaying a sixth garment part, in which the selected third part is attached to the vest part, and purchasing or cancelling the sixth garment part.

The third part may be attached to the vest part using one of a zipper, an open concealed zipper, a nylon zipper, a Vislon zipper, a snap, a magnet, a Velcro, a string, and a button.

The method may further comprise displaying the sixth garment part and selecting a fourth part to be attached to the sixth garment part; and displaying a seventh garment part, in which the selected fourth part is attached to the sixth garment part, and purchasing or cancelling the seventh garment part.

The fourth part may be attached to the sixth garment part using one of a zipper, an open concealed zipper, a nylon zipper, a Vislon zipper, a snap, a magnet, a Velcro, a string, and a button.

In another aspect, there is provided a method of selling an adjustable garment comprising accessing a detachable garment site capable of selling detachable garments; selecting one of a plurality of vest parts in the accessed detachable garment site; displaying the selected vest part and selecting a fourth part to be attached to the vest part; and displaying an eighth garment part, in which the selected fourth part is attached to the vest part, and purchasing or cancelling the eighth garment part.

The fourth part may be attached to the vest part using one of a zipper, an open concealed zipper, a nylon zipper, a Vislon zipper, a snap, a magnet, a Velcro, a string, and a button.

In another aspect, there is provided a method of selling an adjustable garment comprising clicking or accessing an unmanned order machine placed in a store selling detachable garments; selecting one of a plurality of vest parts displayed on the clicked or accessed unmanned order machine; displaying the selected vest part and selecting one of a first part, a third part, or a fourth part to be attached to the vest part; displaying a first garment part in which the first part is attached to the vest part if the first part is selected, displaying a sixth garment part in which the third part is attached to the vest part if the third part is selected, and displaying an eighth garment part in which the fourth part is attached to the vest part if the fourth part is selected; purchasing or cancelling one of the first garment part, the sixth garment part, and the eighth garment part; and if one of the first garment part, the sixth garment part, and the eighth garment part is purchased, providing the purchased first garment part, sixth garment part, or eighth garment part in the store.

The method may further comprise: if one of the first garment part, the sixth garment part, and the eighth garment part is purchased, providing a factory with information about the purchased first garment part, sixth garment part, or eighth garment part; and producing the first garment part, the sixth garment part, and the eighth garment part based on the provided information about the first garment part, the sixth garment part, and the eighth garment part.

The method may further comprise selecting a second part to be attached to the first garment part if the first part is selected; displaying a second garment part, in which the selected second part is attached to the first garment part, and selecting the third part to be attached to the second garment part; and displaying a third garment part, in which the selected third part is attached to the second garment part, and purchasing or cancelling the third garment part.

The method may further comprise selecting the fourth part to be attached to the third garment part; and displaying a fourth garment part, in which the selected fourth part is attached to the third garment part, and purchasing or cancelling the fourth garment part.

The method may further comprise selecting a second part to be attached to the first garment part if the first part is selected; displaying a second garment part, in which the selected second part is attached to the first garment part, and selecting the fourth part to be attached to the second garment part; and displaying a fifth garment part, in which the selected fourth part is attached to the second garment part, and purchasing or cancelling the fifth garment part.

The method may further comprise selecting the fourth part to be attached to the sixth garment part if the third part is selected; and displaying a seventh garment part, in which the selected fourth part is attached to the sixth garment part, and purchasing or cancelling the seventh garment part.

Effects of a method of selling an adjustable garment according to embodiments of the present disclosure are described as follows.

The present disclosure can protect a user's body by coping with situations according to changes in place or weather because each part of a garment is attachable and detachable.

Further, the present disclosure can variously construct a design and an outer appearance of a garment according to individual tastes in a such a way that parts of the garment, each of which is made with various designs, materials, and colors, are individually sold.

In addition, the present disclosure can save the unnecessary cost by purchasing only a damaged part of a garment when the garment is damaged.

### BRIEF DESCRIPTION OF THE DRAWINGS

The accompanying drawings, which are included to provide a further understanding of the disclosure, illustrate embodiments of the disclosure and together with the description serve to explain the principle of the disclosure.

FIG. 1 illustrates a method of selling an adjustable garment according to an embodiment of the present disclosure.

FIGS. 2 to 5 illustrate a method of purchasing, by a user, an adjustable garment according to an embodiment of the present disclosure.

FIG. 6 illustrates a method of selling an adjustable garment according to another embodiment of the present disclosure.

FIGS. 7 and 8 illustrate a method of purchasing, by a user, an adjustable garment according to another embodiment of the present disclosure.

FIG. 9 illustrates a method of selling an adjustable garment according to another embodiment of the present disclosure.

FIG. 10 illustrates a method of purchasing, by a user, an adjustable garment according to another embodiment of the present disclosure.

FIG. 11 illustrates a method of selling an adjustable garment according to another embodiment of the present disclosure.

FIGS. 12 and 13 illustrate a method of purchasing, by a user, an adjustable garment according to another embodiment of the present disclosure.

FIG. 14 illustrates a method of selling an adjustable garment according to another embodiment of the present disclosure.

FIGS. 15 and 16 illustrate a method of purchasing, by a user, an adjustable garment according to another embodiment of the present disclosure.

FIG. 17 illustrates a method of selling an adjustable garment according to another embodiment of the present disclosure.

FIGS. 18 and 19 illustrate a method of purchasing, by a user, an adjustable garment according to another embodiment of the present disclosure.

FIG. 20 illustrates a method of selling an adjustable garment according to another embodiment of the present disclosure.

FIGS. 21 and 22 illustrate a method of purchasing, by a user, an adjustable garment according to another embodiment of the present disclosure.

FIG. 23 illustrates a method of selling an adjustable garment according to another embodiment of the present disclosure.

FIGS. 24 and 25 illustrate a method of purchasing, by a user, an adjustable garment according to another embodiment of the present disclosure.

FIGS. 26 to 28 illustrate the attachment of a vest part and another part in accordance with an embodiment of the present disclosure.

FIG. 29 illustrates a method of selling an adjustable garment according to another embodiment of the present disclosure.

FIG. 30 illustrates a method of producing an adjustable garment at a factory in accordance with another embodiment of the present disclosure.

FIGS. 31 to 33 illustrate a method of selling an adjustable garment according to another embodiment of the present disclosure.

FIG. 34 illustrates a method of selling an adjustable garment according to another embodiment of the present disclosure.

### DETAILED DESCRIPTION OF THE EMBODIMENTS

Reference will now be made in detail to embodiments of the disclosure, examples of which are illustrated in the accompanying drawings. Wherever possible, the same reference numbers will be used throughout the drawings to refer to the same or like parts.

In general, a suffix such as “module” and “unit” may be used to refer to elements or components. Use of such a suffix herein is merely intended to facilitate description of the specification, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When an arbitrary component is described as “being connected to” or “being coupled to” another component, this should be understood to mean that still another component(s) may exist between them, although the arbitrary component may be directly connected to or directly coupled to another component. In contrast, when an arbitrary component is described as “being directly connected to” or “being directly coupled to” another component, this should be understood to mean that no component exists between them.

A singular expression can include a plural expression as long as it does not have an apparently different meaning in context.

In the present application, the terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

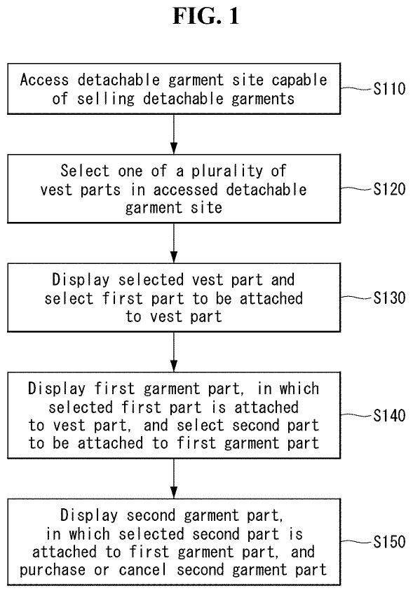

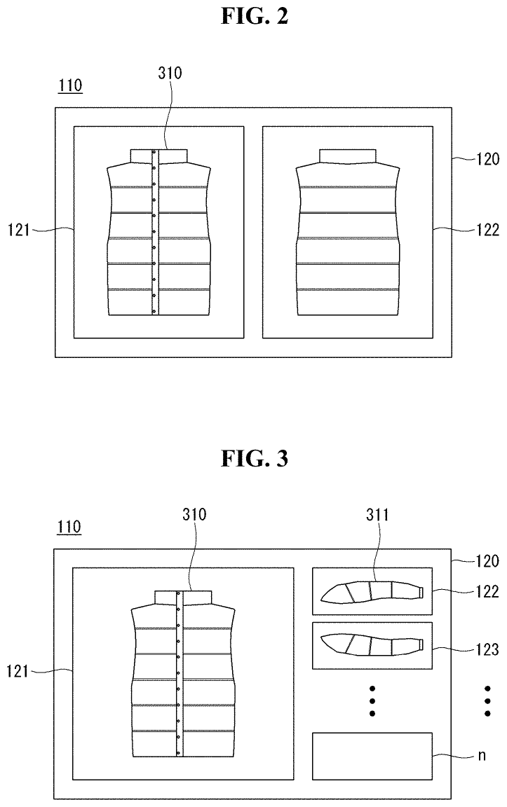

FIG. 1 illustrates a method of selling an adjustable garment according to an embodiment of the present disclosure. FIGS. 2 to 5 illustrate a method of purchasing, by a user, an adjustable garment according to an embodiment of the present disclosure.

Referring to FIGS. 1 to 5, a method of selling an adjustable garment according to an embodiment of the present disclosure may include the following steps.

First, a user may access a detachable garment site 110 capable of selling detachable garments in S110. The user may access the detachable garment site 110 as a member or a non-member. The detachable garment site 110 may be called an adjustable garment site, a garment homepage, or a shopping mall.

The user may select one of a plurality of vest parts 310 in the accessed detachable garment site 110 in S120. The user may click and select one of the plurality of vest parts 310 displayed in the accessed detachable garment site 110. The vest part 310 may include a body, an outer body, a vest, a main part, and the like.

The plurality of vest parts 310 may be distinguished by a design, a material, a size, and a color. For example, the color of the plurality of vest parts 310 may include a black vest part 310, a blue vest part 310, a red vest part 310, a brown vest part 310, a navy vest part 310, a kaki vest part 310, a grey vest part 310, etc. The size of the black vest part 310 may include a 85 size black vest part 310, a 90 size black vest part 310, a 95 size black vest part 310, a 100 size black vest part 310, a 105 size black vest part 310, a 110 size black vest part 310, etc.

As illustrated in FIG. 2, the detachable garment site 110 may be divided into at least one main screen 120. For example, the detachable garment site 110 may display the front of the vest part 310 on a first screen 121 and display the back of the vest part 310 on a second screen 122.

The user may display the selected vest part 310 and select a first part 311 to be attached to the vest part 310 in S130. The detachable garment site 110 may display the vest part 310 selected by the user on a part of the screen. As illustrated in FIG. 3, the detachable garment site 110 may be divided into at least one main screen 120. The screen may be divided into first to n-th screens 121 to (n). The first screen 121 may be displayed at the largest size among the screens. The second to n-th screens 122 to (n) may be displayed at the smaller size than the first screen 121.

The detachable garment site 110 may display the vest part 310 on the first screen 121 and display the first part 311 on the second to n-th screens 122 to (n). The detachable garment site 110 may display designs, materials, sizes, and front colors or back colors of the first part 311 on the second to n-th screens 122 to (n). The first part 311 may be a right sleeve or a left sleeve.

A point of the screen may be displayed on the screen. For example, the point of the screen may be controlled by a mouse of the user or by the user directly touching the screen with his or her finger. If one of the second to n-th screens 122 to (n) overlaps the point of the screen, the overlapped screen may be displayed larger than the remaining screens. Hence, the user can enlarge and see the first part 311 to be selected and check the first part 311 in more detail.

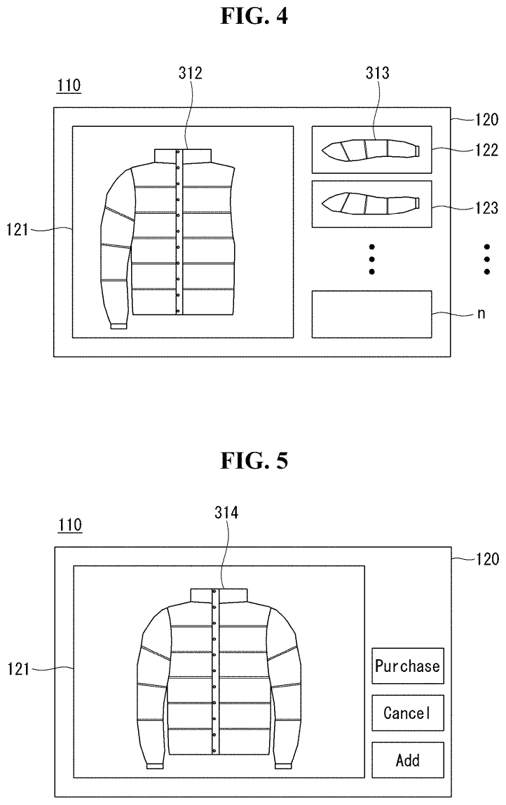

The user may display a first garment part 312, in which the selected first part 311 is attached to the vest part 310, and select a second part 313 to be attached to the first garment part 312 in S140. The first garment part 312 may be a garment in which a right part or a left part is attached to the vest part 310. As illustrated in FIG. 4, the detachable garment site 110 may display the first garment part 312 selected by the user on the first screen 121 and display the second part 313 on the second to n-th screens 122 to (n). The detachable garment site 110 may display designs, materials, sizes and front colors or back colors of the second part 313 on the second to n-th screens 122 to (n). The second part 313 may be a right sleeve or a left sleeve. For example, if the first part 311 is a right sleeve, the second part 313 may be a left sleeve. If the first part 311 is a left sleeve, the second part 313 may be a right sleeve.

The first part 311 or the second part 313 may be attached to the vest part 310 using one of a zipper, an open concealed zipper, a nylon zipper, a Vision zipper, a snap, a magnet, a Velcro, a string, and a button. This will be described in detail later.

The first part 311 and the second part 313 each may have a different length. For example, the first part 311 may include 1-1 to 1-n parts. The 1-1 to 1-n parts may be made with different lengths. The second part 313 may include 2-1 to 2-n parts. The 2-1 to 2-n parts may be made with different lengths. Hence, the user can select the first part 311 and the second part 313 suitably for his/her arm's length.

The user may display a second garment part 314, in which the selected second part 313 is attached to the first garment part 312, and purchase or cancel the second garment part 314 in S150. As illustrated in FIG. 5, the second garment part 314 may be a garment in which a right sleeve and a left sleeve are attached to a vest.

The detachable garment site 110 may convert the second garment part 314, that is selected by the user and is completed with a garment, into a 3D video. The detachable garment site 110 may display the second garment part 314 at various angles or in various directions by converting the second garment part 314 into the 3D video.

Afterwards, when the user purchases the second garment part 314, the user may add a third part 315 to the second garment part 314. In other words, the detachable garment site 110 may display a photograph or a 3D video for a combined visual of the vest part 310 selected by the user and the first and second parts 311 and 313 which the user intends to select. And then, the detachable garment site 110 may display colors, materials, designs, etc. of other parts that may be additionally selected.

Hence, the user can check a final photograph and a 3D video, to which other parts are combined or attached based on the vest part 310 finally selected by the user, and determine to purchase or cancel the product.

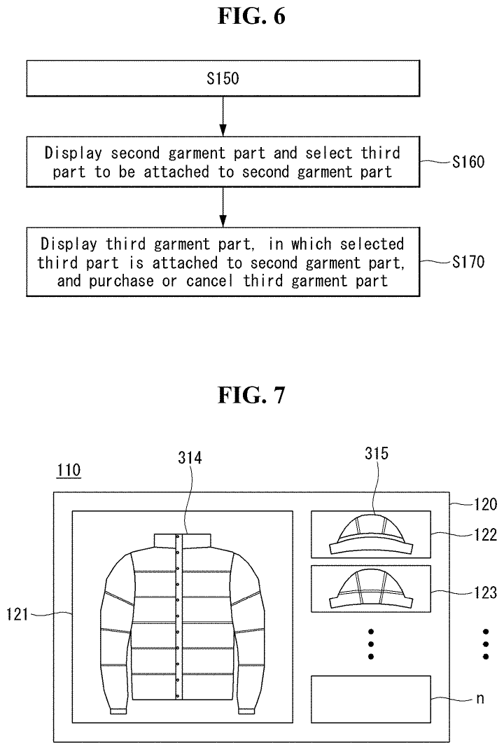

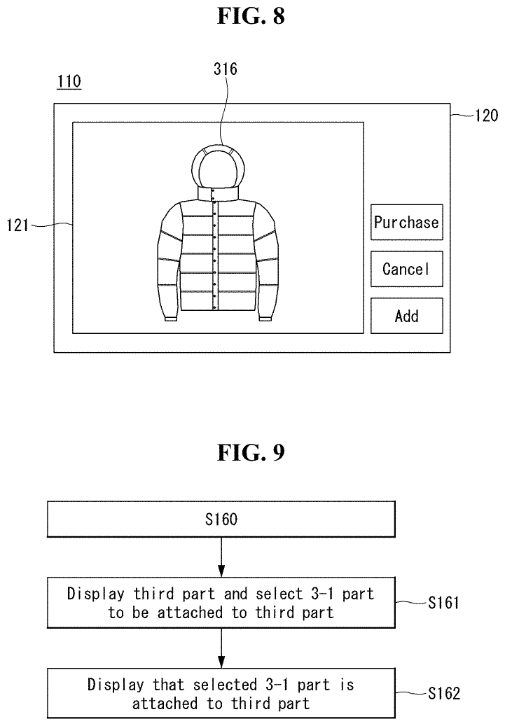

FIG. 6 illustrates a method of selling an adjustable garment according to another embodiment of the present disclosure. FIGS. 7 and 8 illustrate a method of purchasing, by a user, an adjustable garment according to another embodiment of the present disclosure.

Referring to FIGS. 6 to 8, the detachable garment site 110 may display the second garment part 314 and select the third part 315 to be attached to the second garment part 314 in S160. The detachable garment site 110 may display the second garment part 314 selected by the user on the first screen 121 and display the third part 315 on the second to n-th screens 122 to (n). The detachable garment site 110 may display designs, materials, sizes, and colors of the third part 315 on the second to n-th screens 122 to (n). For example, the third part 315 may be a hood.

The user may display a third garment part 316, in which the selected third part 315 is attached to the second garment part 314, and purchase or cancel the third garment part 316 in S170. As illustrated in FIG. 8, the third garment part 316 may be a garment in which a right sleeve, a left sleeve, and a hood are attached to a vest. When the user purchases the third garment part 316, the user may add a 3-1 part and/or a fourth part 317 to the third garment part 316.

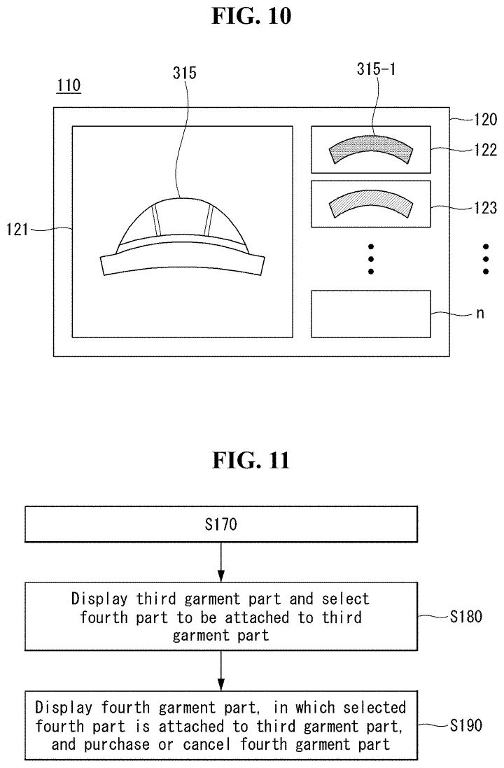

FIG. 9 illustrates a method of selling an adjustable garment according to another embodiment of the present disclosure. FIG. 10 illustrates a method of purchasing, by a user, an adjustable garment according to another embodiment of the present disclosure.

Referring to FIGS. 9 and 10, the detachable garment site 110 may display the third part 315 and select a 3-1 part to be attached to the third part 315 in S161. The detachable garment site 110 may display the third part 315 selected by the user on the first screen 121 and display the 3-1 part on the second to n-th screens 122 to (n). The detachable garment site 110 may display designs, materials, sizes, and colors of the 3-1 part on the second to n-th screens 122 to (n). For example, the 3-1 part may be a hood fur.

If the user selects one of a plurality of 3-1 parts, the detachable garment site 110 may display, that the 3-1 part selected by the user is attached to the third part 315, on the first screen 121 in S162.

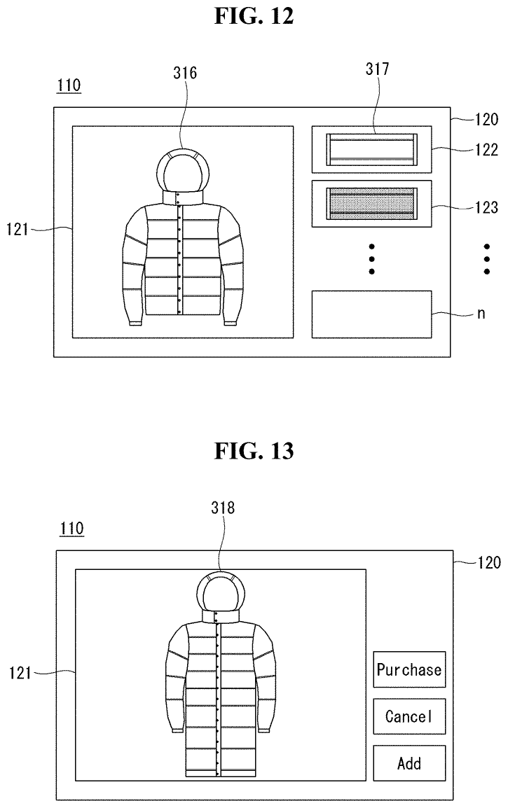

FIG. 11 illustrates a method of selling an adjustable garment according to another embodiment of the present disclosure. FIGS. 12 and 13 illustrate a method of purchasing, by a user, an adjustable garment according to another embodiment of the present disclosure.

Referring to FIGS. 11 to 13, the detachable garment site 110 may display the third garment part 316 and select a fourth part 317 to be attached to the third garment part 316 in S180. The detachable garment site 110 may display the third garment part 316 selected by the user on the first screen 121 and display the fourth part 317 on the second to n-th screens 122 to (n). The detachable garment site 110 may display designs, materials, sizes, and colors of the fourth part 317 on the second to n-th screens 122 to (n). For example, the fourth part 317 may be a bottom hem part.

The fourth part 317 may have different lengths. For example, the fourth part 317 may include 4-1 to 4-n parts. The 4-1 to 4-n parts may be made with different lengths. Hence, the user can select the fourth part 317 suitable for his/her height.

The user may display a fourth garment part 318, in which the selected fourth part 317 is attached to the third garment part 316, and purchase or cancel the fourth garment part 318 in S190. As illustrated in FIG. 13, the fourth garment part 318 may be a garment in which a right sleeve, a left sleeve, a hood, and a bottom hem are attached to a vest.

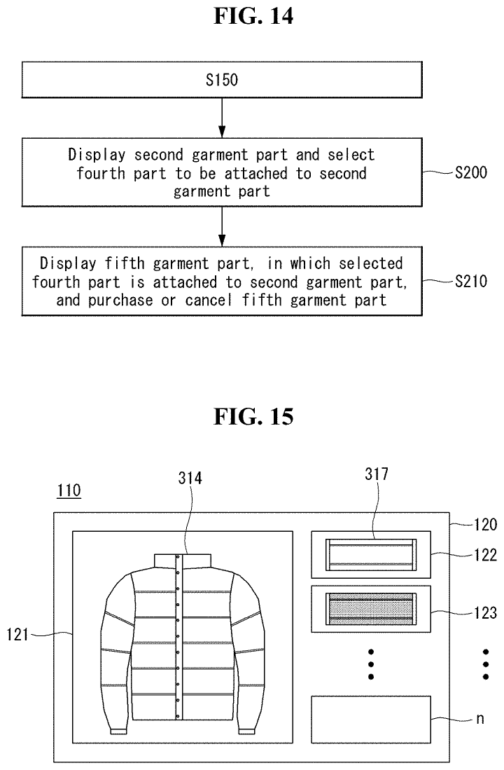

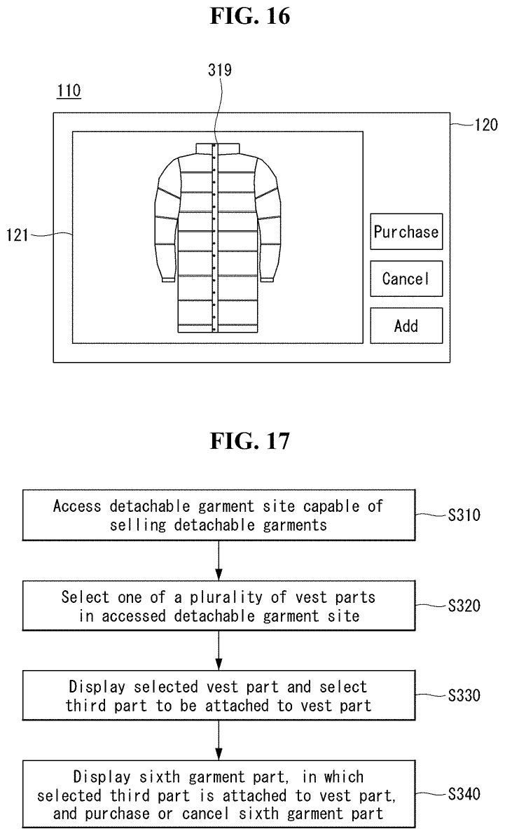

FIG. 14 illustrates a method of selling an adjustable garment according to another embodiment of the present disclosure. FIGS. 15 and 16 illustrate a method of purchasing, by a user, an adjustable garment according to another embodiment of the present disclosure.

Referring to FIGS. 14 to 16, the detachable garment site 110 may display the second garment part 314 and select a fourth part 317 to be attached to the second garment part 314 in S200. The detachable garment site 110 may display the second garment part 314 selected by the user on the first screen 121 and display the fourth part 317 on the second to n-th screens 122 to (n). The detachable garment site 110 may display designs, materials, sizes, and colors of the fourth part 317 on the second to n-th screens 122 to (n). For example, the fourth part 317 may be a bottom hem part.

The user may display a fifth garment part 319, in which the selected fourth part 317 is attached to the second garment part 314, and purchase or cancel the fifth garment part 319 in S210. As illustrated in FIG. 16, the fifth garment part 319 may be a garment in which a right sleeve, a left sleeve, and a bottom hem are attached to a vest.

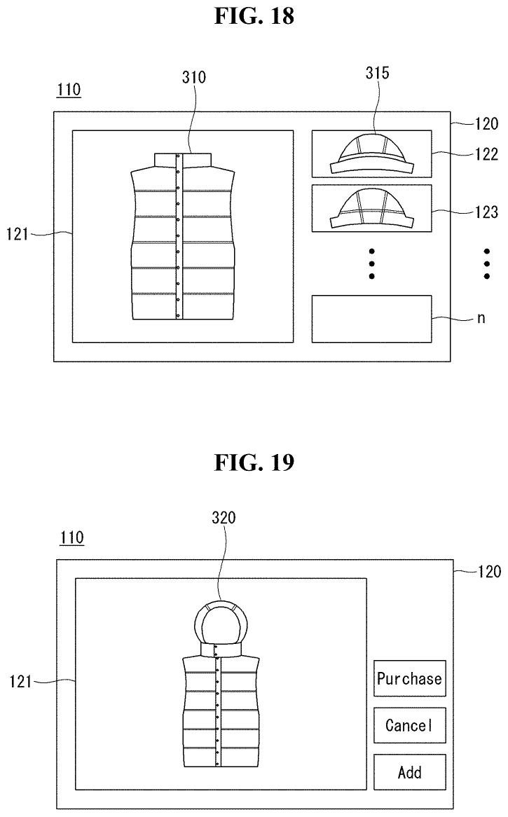

FIG. 17 illustrates a method of selling an adjustable garment according to another embodiment of the present disclosure. FIGS. 18 and 19 illustrate a method of purchasing, by a user, an adjustable garment according to another embodiment of the present disclosure.

Referring to FIGS. 17 to 19, a method of selling an adjustable garment according to an embodiment of the present disclosure may include the following steps.

First, a user may access a detachable garment site 110 capable of selling detachable garments in S310. The user may access the detachable garment site 110 as a member or a non-member.

The user may select one of a plurality of vest parts 310 in the accessed detachable garment site 110 in S320. The user may click and select one of the plurality of vest parts 310 displayed in the accessed detachable garment site 110. The vest part 310 was sufficiently described above with reference to FIGS. 1 to 5, and thus this description is omitted here.

The user may display the selected vest part 310 and select a third part 315 to be attached to the vest part 310 in S330. As illustrated in FIG. 18, the detachable garment site 110 may display the vest part 310 on a first screen 121 and display the third part 315 on second to n-th screens 122 to (n). The detachable garment site 110 may display designs, materials, sizes, and front colors or back colors of the third part 315 on the second to n-th screens 122 to (n). The third part 315 may be a hood.

The third part 315 may be attached to the vest part 310 using one of a zipper, an open concealed zipper, a nylon zipper, a Vision zipper, a snap, a magnet, a Velcro, a string, and a button. This will be described in detail later.

The user may display a sixth garment part 320, in which the selected third part 315 is attached to the vest part 310, and purchase or cancel the sixth garment part 320 in S340. As illustrated in FIG. 19, the sixth garment part 320 may be a garment in which a hood is attached to a vest. When the user purchases the sixth garment part 320, the user may add a fourth part 317 to the sixth garment part 320.

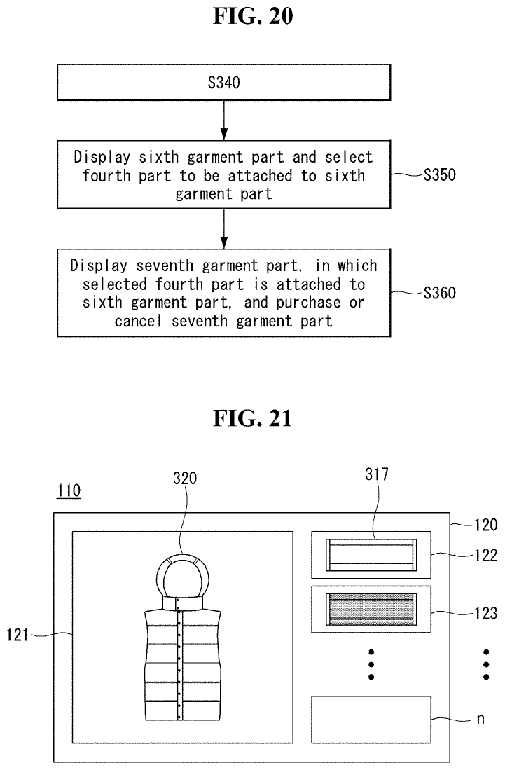

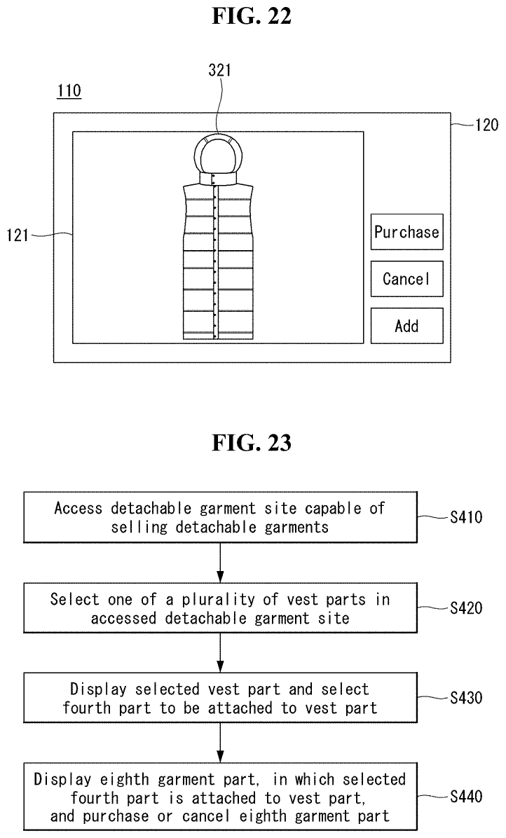

FIG. 20 illustrates a method of selling an adjustable garment according to another embodiment of the present disclosure. FIGS. 21 and 22 illustrate a method of purchasing, by a user, an adjustable garment according to another embodiment of the present disclosure.

Referring to FIGS. 20 to 22, the detachable garment site 110 may display the sixth garment part 320 and select the fourth part 317 to be attached to the sixth garment part 320 in S350. The detachable garment site 110 may display the sixth garment part 320 selected by the user on the first screen 121 and display the fourth part 317 on the second to n-th screens 122 to (n). The detachable garment site 110 may display designs, materials, sizes, and colors of the fourth part 317 on the second to n-th screens 122 to (n). For example, the fourth part 317 may be a bottom hem part.

The user may display a seventh garment part 321, in which the selected fourth part 317 is attached to the sixth garment part 320, and purchase or cancel the seventh garment part 321 in S360. As illustrated in FIG. 22, the seventh garment part 321 may be a garment in which a hood and a bottom hem are attached to a vest.

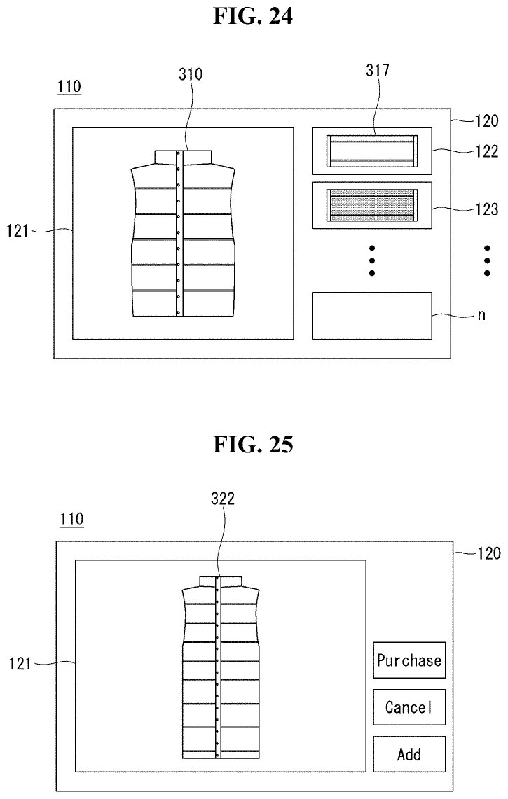

FIG. 23 illustrates a method of selling an adjustable garment according to another embodiment of the present disclosure. FIGS. 24 and 25 illustrate a method of purchasing, by a user, an adjustable garment according to another embodiment of the present disclosure.

Referring to FIGS. 23 to 25, a method of selling a detachable garment according to an embodiment of the present disclosure may include the following steps.

First, a user may access a detachable garment site 110 capable of selling detachable garments in S410. The user may access the detachable garment site 110 as a member or a non-member.

The user may select one of a plurality of vest parts 310 in the accessed detachable garment site 110 in S420. The user may click and select one of the plurality of vest parts 310 displayed in the accessed detachable garment site 110. The vest part 310 was sufficiently described above with reference to FIGS. 1 to 5, and thus this description is omitted here.

The user may display the selected vest part 310 and select a fourth part 317 to be attached to the vest part 310 in S430. As illustrated in FIG. 24, the detachable garment site 110 may display the vest part 310 on a first screen 121 and display the fourth part 317 on second to n-th screens 122 to (n). The detachable garment site 110 may display designs, materials, sizes, and front colors or back colors of the fourth part 317 on the second to n-th screens 122 to (n). The fourth part 317 may be a bottom hem part.

The fourth part 317 may be attached to the vest part 310 using one of a zipper, an open concealed zipper, a nylon zipper, a Vislon zipper, a snap, a magnet, a Velcro, a string, and a button. This will be described in detail later.

The user may display an eighth garment part 322, in which the selected fourth part 317 is attached to the vest part 310, and purchase or cancel the eighth garment part 322 in S440. As illustrated in FIG. 25, the eighth garment part 322 may be a garment in which a bottom hem is attached to a vest.

As described above, the method of selling the detachable garment according to embodiments of the present disclosure can protect a user's body by coping with situations according to changes in place or weather because each part of a garment is attachable and detachable.

Further, the method of selling the detachable garment according to embodiments of the present disclosure can variously construct a design and an outer appearance of the garment according to individual tastes in a such a way that parts of the garment, each of which is made with various designs, materials, and colors, are individually sold.

In addition, the method of selling the detachable garment according to embodiments of the present disclosure can save the unnecessary cost by purchasing only a damaged part of a garment when the garment is damaged.

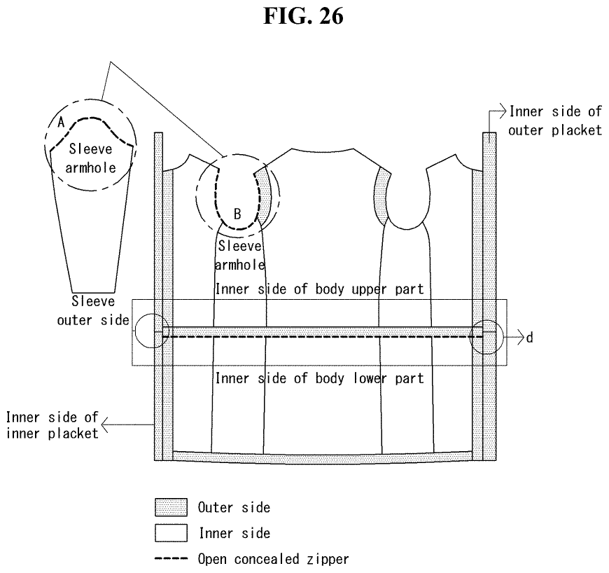

FIGS. 26 to 28 illustrate the attachment of a vest part and another part in accordance with an embodiment of the present disclosure.

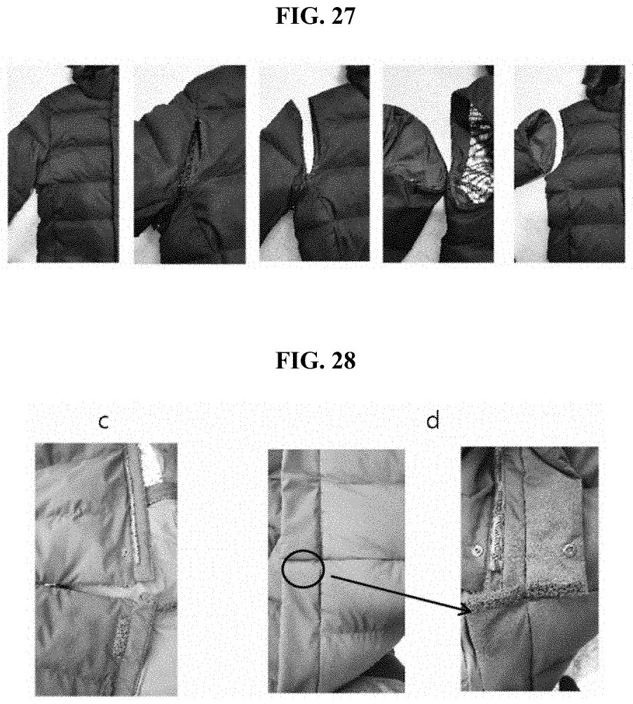

Referring to FIGS. 26 and 27, a vest part may include sleeve armholes B. A first part and a second part each may include a sleeve armhole A. An open concealed zipper may be attached to the sleeve armholes B of the vest part. An open concealed zipper may be attached to the sleeve armhole A of each of the first part and the second part.

The first part and the second part may be attached to the vest part by connecting the open concealed zippers of the sleeve armholes A of the first part and the second part to the open concealed zippers of the sleeve armholes B of the vest part.

Referring to FIGS. 26 and 28, an open concealed zipper may be attached to the bottom of an inner surface of the vest part. An open concealed zipper may be attached to the top of an inner surface of a fourth part. The fourth part may be attached to the vest part by connecting the open concealed zipper of the fourth part to the open concealed zipper of the vest part.

(c) of FIG. 28 illustrates that a Velcro is attached to an inner placket of a lower part of the vest part, a Velcro is attached to an inner placket of an upper part of the fourth part, and the Velcro of the vest part is connected to the Velcro of the fourth part. Further, (d) of FIG. 28 illustrates that a Velcro is attached to an outer placket of the lower part of the vest part, a Velcro is attached to an outer placket of the upper part of the fourth part, and the Velcro of the vest part and the Velcro of the fourth part are connected to and separated from each other.

As described above, a slider and a bottom stop of the open concealed zipper can be hidden not to be seen from the outside by attaching the Velcro of the inner/outer placket of the vest part to the Velcro of the inner/outer placket of the fourth part.

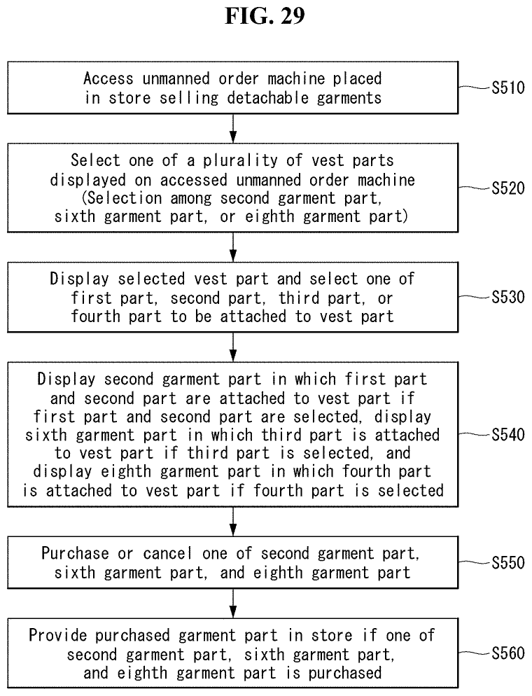

FIG. 29 illustrates a method of selling an adjustable garment according to another embodiment of the present disclosure.

Referring to FIG. 29, the present disclosure may click or access an unmanned order machine placed in a store selling detachable garments in S510. A user may visit the store and access an unmanned order machine installed in the store or a homepage. Alternatively, the user may visit the store and directly confirm various detachable garments displayed in the store.

Next, the present disclosure may select one of a plurality of vest parts displayed on the clicked or accessed unmanned order machine in S520. The user may click and select one of a plurality of vest parts displayed on the accessed unmanned order machine. Alternatively, the user may directly confirm a plurality of vest parts displayed in the store and select one of the plurality of vest parts. Since the detailed description of the vest part was made above, this description is omitted here. FIG. 29 illustrates that a plurality of parts is selected based on the vest part, but the present disclosure is not limited thereto. For example, the present disclosure may select a plurality of parts based on a second garment part, a sixth garment part, and an eighth garment part.

The user may display the selected vest part and select one of a first part, a second part, a third part, or a fourth part to be attached to the vest part in S530.

The present disclosure may display a second garment part in which the first part and the second part are attached to the vest part if the user selects the first part and the second part, display a sixth garment part in which the third part is attached to the vest part if the user selects the third part, and display an eighth garment part in which the fourth part is attached to the vest part if the user selects the fourth part in S540.

The user may purchase or cancel one of the second garment part, the sixth garment part, and the eighth garment part in S550. Since the description of the steps S530 to S550 can be sufficiently inferred from the above description, this description is omitted here.

If the user purchases one of the second garment part, the sixth garment part, and the eighth garment part, the purchased garment part can be provided in the store in S560. If the user purchases one of the second garment part, the sixth garment part, and the eighth garment part, the user may directly wear the purchased garment part at the store and immediately repair the purchased garment part according to his/her body.

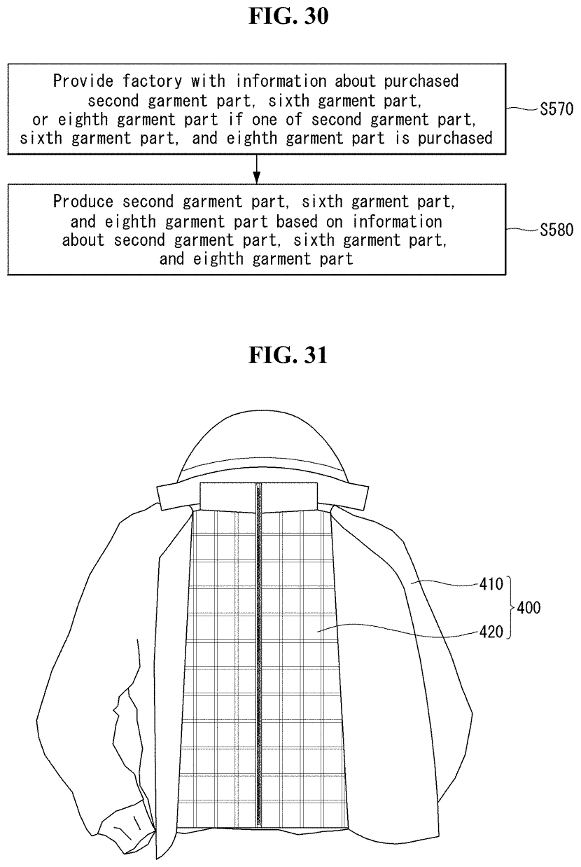

FIG. 30 illustrates a method of producing an adjustable garment at a factory in accordance with another embodiment of the present disclosure.

Referring to FIG. 30, if the user purchases one of a second garment part, a sixth garment part, and an eighth garment part, the present disclosure may provide a factory with information about the purchased second garment part, sixth garment part, or eighth garment part in S570.

If the user directly visits a clothing store or a clothing factory and orders a garment using an unmanned order machine placed in the clothing store or the clothing factory, information thereof may be immediately provided to the factory.

The information provided to the factory may include clothing information about the second garment part, the sixth garment part, and the eighth garment part which the user intends to purchase, and personal information about the user's body.

For example, the present disclosure may adjust a detachable garment selected by the user according to the user's body size by transmitting both clothing information about the detachable garment and user's body information to the factory.

Next, the present disclosure may produce the second garment part, the sixth garment part, and the eighth garment part based on the provided information about the second garment part, the sixth garment part, and the eighth garment part in S580. The present disclosure may rapidly and accurately produce a detachable garment suitable for the user's body size or an environment around the user by additionally providing the user's body information to the second garment part, the sixth garment part, and the eighth garment part selected by the user.

So far, the present disclosure has described and illustrated that a detachable garment suitable for the user's body size or an environment around the user is produced by attaching at least one garment selected by the user to the vest part 310 (see FIG. 2), but is not limited thereto.

For example, the present disclosure may produce a detachable garment suitable for the user's body size or an environment around the user by attaching at least one garment selected by the user to the second garment part 314 (see FIG. 5). Since this was sufficiently described with reference to FIGS. 5 to 16, the description thereof is omitted here.

Further, the present disclosure can combine parts, that many users or consumers choose or prefer in offline or online, etc., and complete an adjustable garment. The present disclosure can change in real time the completed adjustable garment according to the chosen or preferred parts and display it to the user or the consumer.

FIGS. 31 to 33 illustrate a method of selling an adjustable garment according to another embodiment of the present disclosure.

Referring to FIG. 31, an adjustable garment according to another embodiment of the present disclosure may include a Triclimate garment 400. The Triclimate garment 400 may include an outer part 410 and an inner part 420. The outer part 410 and the inner part 420 of the Triclimate garment 400 may be separated from each other to function as a separate outerwear, or both the outer part 410 and the inner part 420 may function as an outerwear together. The Triclimate garment 400 may be in 3-in-1 style. For example, the outer part 410 may include a simple style windbreaker jacket, etc., and the inner part 420 may include a slim fit down jacket, etc.

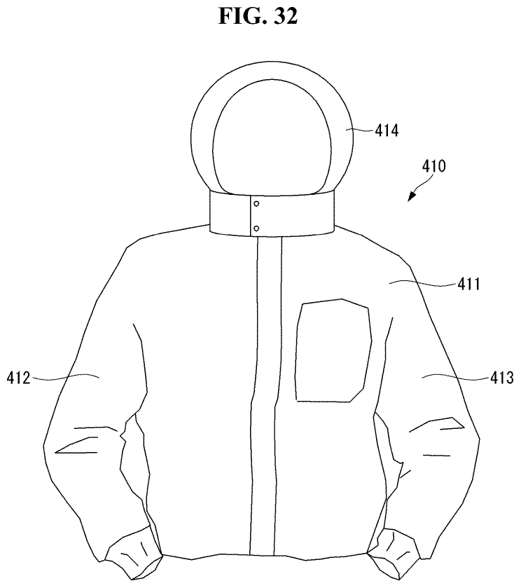

Referring to FIG. 32, the outer part 410 of the Triclimate garment 400 may consist of a plurality of parts 411 to 414.

The outer part 410 may include a vest part 411 and first to third parts 412 to 414. Since a method of purchasing the outer part 410 was described in detail with reference to FIGS. 1 to 10, the description thereof is omitted.

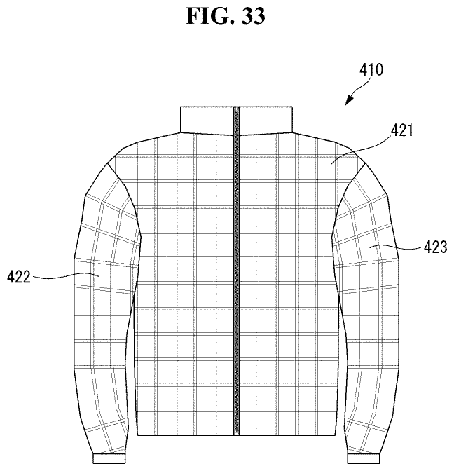

Referring to FIG. 33, the inner part 420 of the Triclimate garment 400 may consist of a plurality of parts 421 to 423.

The inner part 420 may include a vest part 421 and first and second parts 422 and 423. Since a method of purchasing the inner part 420 was described in detail with reference to FIGS. 1 to 6, the description thereof is omitted.

As described above with reference to FIGS. 31 to 33, the Triclimate garment 400 may include the outer part 410 and the inner part 420, and the outer part 410 and the inner part 420 may consist of one or more parts 411 to 414 or 421 to 423. Hence, the customer can directly choose each part of a Triclimate garment with a desired material, color, and design to construct a garment, variously construct desired parts of the Triclimate garment online, and confirm in advance and purchase various combinations.

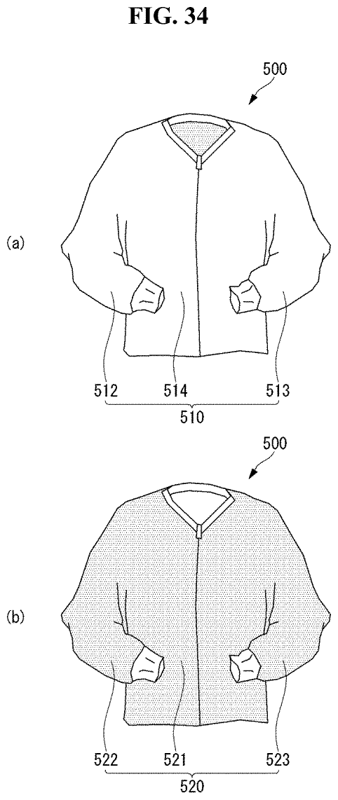

FIG. 34 illustrates a method of selling an adjustable garment according to another embodiment of the present disclosure.

Referring to FIG. 34, an adjustable garment according to another embodiment of the present disclosure may include a reversible garment 500.

The reversible garment 500 may be a garment that can be worn on both sides when turned inside out. The reversible garment 500 may be a garment that applies different designs and colors to both sides of a jacket. The reversible garment 500 may be a 2-way style garment that applies different designs and colors to both sides of the jacket. For example, as illustrated in (a) of FIG. 34, one side 510 of a jacket in the reversible garment 500 may be of a basic style and may be a daily outer that matches with school uniforms, suits, etc. Further, as illustrated in (b) of FIG. 34, the other side 520 of the reversed jacket may be an outer that is transformed into a new style-down of a color block and can match with casual denim and skirts to accentuate the trendy.

The reversible garment 500 may consist of a plurality of parts.

The reversible garment 500 may include vest parts 511, 521, first parts 512, 522, and second parts 513, 523. Since a method of purchasing the reversible garment 500 was described in detail with reference to FIGS. 1 to 6, the description thereof is omitted.

As illustrated in FIG. 34, the reversible garment 500 may include one or more parts 511 to 513 and 521 to 523, and each of the parts 511 to 513 and 521 to 523 can be turned inside out and worn on both sides. Hence, the customer can directly choose each of the parts 511 to 513 and 521 to 523 with a desired material, color and design to construct a garment, variously construct desired parts of the reversible garment online, and confirm in advance and purchase various combinations.

The adjustable garment according to embodiments of the present disclosure may consist of at least one part and can be applied to the Triclimate garment or the reversible garment. Therefore, the customer can directly choose each part of the product with a desired material, color and design and construct a unique product that is able to perfectly reflect customer's tastes.

Further, the customer can easily and variously construct desired parts of a product online or offline, confirm in advance various combinations of the parts at various angles or direction, and purchase a unique product capable of applying customer's tastes.

Some embodiments or other embodiments of the disclosure described above are not exclusive or distinct from each other. Some embodiments or other embodiments of the disclosure described above can be used together or combined in configuration or function.

The above detailed description is merely an example and is not to be considered as limiting the present disclosure. The scope of the present disclosure should be determined by rational interpretation of the appended claims, and all changes within the equivalent range of the present disclosure are included in the scope of the present disclosure.

What is claimed is:

1. A method of selling an adjustable garment comprising:
accessing a detachable garment site capable of selling detachable garments;
selecting one of a plurality of vest parts in the accessed detachable garment site;
displaying the selected vest part and selecting a first part to be attached to the vest part;
displaying a first garment part, in which the selected first part is attached to the vest part, and selecting a second part to be attached to the first garment part; and
displaying a second garment part, in which the selected second part is attached to the first garment part, and purchasing or cancelling the second garment part.

2. The method of claim 1, further comprising:
displaying the second garment part and selecting a third part to be attached to the second garment part; and
displaying a third garment part, in which the selected third part is attached to the second garment part, and purchasing or cancelling the third garment part.

3. The method of claim 2, wherein the first part or the second part is attached to the vest part using one of a zipper, an open concealed zipper, a nylon zipper, a Vislon zipper, a snap, a magnet, a Velcro, a string, and a button,
wherein the third part is attached to the second garment part using one of a zipper, an open concealed zipper, a nylon zipper, a Vislon zipper, a snap, a magnet, a Velcro, a string, and a button.

4. The method of claim 2, further comprising:
displaying the third garment part and selecting a fourth part to be attached to the third garment part; and
displaying a fourth garment part, in which the selected fourth part is attached to the third garment part, and purchasing or cancelling the fourth garment part.

5. The method of claim 4, wherein the fourth part is attached to the third garment part using one of a zipper, an open concealed zipper, a nylon zipper, a Vislon zipper, a snap, a magnet, a Velcro, a string, and a button.

6. The method of claim 1, further comprising:
displaying the second garment part and selecting a fourth part to be attached to the second garment part; and
displaying a fifth garment part, in which the selected fourth part is attached to the second garment part, and purchasing or cancelling the fifth garment part.

7. The method of claim 6, wherein the fourth part is attached to the second garment part using one of a zipper, an open concealed zipper, a nylon zipper, a Vislon zipper, a snap, a magnet, a Velcro, a string, and a button.

8. The method of claim 2, wherein the second garment part or the third garment part includes a Triclimate garment or a reversible garment.

9. A method of selling an adjustable garment comprising:
accessing a detachable garment site capable of selling detachable garments;
selecting one of a plurality of vest parts in the accessed detachable garment site;
displaying the selected vest part and selecting a third part to be attached to the vest part;
displaying a sixth garment part, in which the selected third part is attached to the vest part, and purchasing or cancelling the sixth garment part;
accessing a detachable garment site capable of selling detachable garments;
selecting one of a plurality of vest parts in the accessed detachable garment site;
displaying the selected vest part and selecting a fourth part to be attached to the vest part; and
displaying an eighth garment part, in which the selected fourth part is attached to the vest part, and purchasing or cancelling the eighth garment part.

10. The method of claim 9, wherein the third part is attached to the vest part using one of a zipper, an open concealed zipper, a nylon zipper, a Vislon zipper, a snap, a magnet, a Velcro, a string, and a button.

11. The method of claim 9, further comprising:
displaying the sixth garment part and selecting a fourth part to be attached to the sixth garment part; and
displaying a seventh garment part, in which the selected fourth part is attached to the sixth garment part, and purchasing or cancelling the seventh garment part.

12. The method of claim 11, wherein the fourth part is attached to the sixth garment part using one of a zipper, an open concealed zipper, a nylon zipper, a Vislon zipper, a snap, a magnet, a Velcro, a string, and a button.

13. The method of claim 9, wherein the fourth part is attached to the vest part using one of a zipper, an open concealed zipper, a nylon zipper, a Vislon zipper, a snap, a magnet, a Velcro, a string, and a button.

14. A method of selling an adjustable garment comprising:
clicking or accessing an unmanned order machine placed in a store selling detachable garments;
selecting one of a plurality of vest parts displayed on the clicked or accessed unmanned order machine;
displaying the selected vest part and selecting one of a first part, a third part, or a fourth part to be attached to the vest part;
displaying a first garment part in which the first part is attached to the vest part if the first part is selected, displaying a sixth garment part in which the third part is attached to the vest part if the third part is selected, and displaying an eighth garment part in which the fourth part is attached to the vest part if the fourth part is selected;
purchasing or cancelling one of the first garment part, the sixth garment part, and the eighth garment part; and
if one of the first garment part, the sixth garment part, and the eighth garment part is purchased, providing the purchased first garment part, sixth garment part, or eighth garment part in the store.

15. The method of claim 14, further comprising:
if one of the first garment part, the sixth garment part, and the eighth garment part is purchased, providing a factory with information about the purchased first garment part, sixth garment part, or eighth garment part; and
producing the first garment part, the sixth garment part, and the eighth garment part based on the provided information about the first garment part, the sixth garment part, and the eighth garment part.

16. The method of claim 14, further comprising:
selecting a second part to be attached to the first garment part if the first part is selected;
displaying a second garment part, in which the selected second part is attached to the first garment part, and selecting the third part to be attached to the second garment part; and
displaying a third garment part, in which the selected third part is attached to the second garment part, and purchasing or cancelling the third garment part.

17. The method of claim 16, further comprising:
selecting the fourth part to be attached to the third garment part; and
displaying a fourth garment part, in which the selected fourth part is attached to the third garment part, and purchasing or cancelling the fourth garment part.

18. The method of claim 14, further comprising:
selecting a second part to be attached to the first garment part if the first part is selected;
displaying a second garment part, in which the selected second part is attached to the first garment part, and selecting the fourth part to be attached to the second garment part; and
displaying a fifth garment part, in which the selected fourth part is attached to the second garment part, and purchasing or cancelling the fifth garment part.

19. The method of claim 14, further comprising:
selecting the fourth part to be attached to the sixth garment part if the third part is selected; and
displaying a seventh garment part, in which the selected fourth part is attached to the sixth garment part, and purchasing or cancelling the seventh garment part.
